(19) United States
(12) Patent Application Publication
(10) Pub. No.: US 2016/0341344 A1
(43) Pub. Date: Nov. 24, 2016

(54) HIGH DEFLECTION UNRESTRAINED PIPE JOINT

(71) Applicant: McWane, Inc., Birmingham, AL (US)

(72) Inventor: Daniel A. Copeland, Bessemer, AL (US)

(21) Appl. No.: 14/717,358

(22) Filed: May 20, 2015

(51) Int. Cl. F16L 27/02

(52) U.S. Cl. CPC F16L 27/02

(57) ABSTRACT

The present disclosure generally pertains to systems and methods for an improved pipe joint. The system includes a first pipe having a bell socket end and a second pipe having a male or spigot end. The bell socket end of the first pipe is configured to include an inner groove within which a sealing member may be inserted. The bell socket end of the first pipe further includes a pivot cavity. The spigot end of the second pipe may be inserted into socket end of the first pipe to form an unrestrained, push-fit, ring-seal assembly when operatively joined, such that a sealing member is located within the inner groove, the sealing member having a sealing surface that is longitudinally related with the pivot point of the two pipes thereby allowing a high joint deflection angle while maintaining a relatively small pipe bell and sealing member mass.

### FIELD OF INVENTION

The present invention relates generally to an unrestrained pipe joint, and more particularly, to a pipe joint including a spigot end of a second pipe that is angularly deflectable within a bell socket end of a first pipe about a pivot point that has a specified positional relationship with an annular seal of the bell socket end.

### BACKGROUND OF THE INVENTION

Telescopically assembled pipes are used in numerous applications. In short, the spigot end of one pipe is inserted into the socket end of a second pipe. The opening of the socket end of tone pipe is configured to receive the spigot end of another pipe, which becomes partially enclosed by the first pipe. A sealing member, such as a gasket may be inserted in the socket end to enhance the seal between the two pipes.

Telescopically assembled pipe joints that include tight seals, which also allow for high deflection (pivot) angles, however, remain a challenge for conventional pipe manufacturers. The cost and bulk of a typical joint required to achieve such unrestrained, high deflection pipe angles remains burdensome or necessitates the use of a separate pipe fitting between the two pipes. Ball and socket joints, for example, must be machined within close tolerances and are relatively expensive to produce. Typical telescopically assembled joints require large bulky bells and sealing members to accommodate even moderate deflections. Therefore, a need exists for a low cost, high deflection, low weight, unrestrained pipe joint.

### SUMMARY OF INVENTION

The present disclosure is directed to an improved pipe joining system including a first pipe having a bell or socket end and a second pipe having a male or spigot end, the pipes configured to form an unrestrained, push-fit, ring-seal assembly when operatively joined, the joined pipes capable of a high deflection angle.

The present disclosure is also directed to an improved pipe joining system using lightweight components relative to those of conventional pipe joints.

The present disclosure is also directed to an improved pipe joining system that is simply to manufacture relative to conventional pipe joints.

The present disclosure is also directed to an improved pipe joining system configured to maintain an airtight and watertight seal. The present disclosure is also directed to an improved pipe joining system configured to maintain an airtight and watertight seal while the interior of such pipes are under high pressure.

The present disclosure is further directed to a method of joining two pipes wherein the spigot end of a second pipe is inserted into the bell socket end of a first pipe, the bell socket including a groove containing a sealing member, the bell socket further including a pivot cavity configured to allow a high deflection angle for the two pipes.

The present disclosure is further directed to a pipe joint formed by a first pipe having a longitudinal axis and a bell end including an annular groove. Seated within the annular groove is an annular compressible member having an inner face defining an opening. A spigot end of a second pipe is inserted into the bell end and through the opening thereby forming an annular seal between the annular compressible member and the spigot end, the annular seal having an axially extending width. A pivot point about which the second pipe pivots relative to the first pipe is formed by joining the first and second pipe. The pivot point is coincident with a pivot plane extending perpendicularly through the longitudinal axis of the first pipe and through the annular compressible member. A sealing plane is also formed that extends perpendicularly through the longitudinal axis of the first pipe at a second point and through a center of the width of the annular seal, the second point being a desired distance from the pivot point. The desired distance may be 0% to 15%; 0% to 0.5%; 0.5% to 14%; 0.75% to 13%; 1% to 12%; 1.25% to 11%; 1.5% to 10%; 2% to 9%; 2.25% to 8%; 2.5% to 7%; 3% to 6; or 4% to 5% of the outer diameter of the spigot end.

Other objects, features and advantages of the present disclosure will become apparent from the following detailed description given with reference to the accompanying figures.

### BRIEF DESCRIPTION OF THE DRAWINGS

The present disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 depicts a portion of the cross-section of an exemplary female bell socket of a pipe.

FIG. 2 depicts a cross-section of a pipe sealing member containing a foot portion.

FIG. 3 depicts a cross-section of a pipe sealing member located within the bell socket of a pipe.

FIG. 4 depicts an exemplary pipe sealing member.

FIG. 5 depicts a cross-section of an exemplary pipe sealing member containing a foot portion.

FIG. 6 depicts the spigot end of a second pipe fitted into the bell socket end of a first pipe, the pipes secured by a sealing member fitted within the bell socket, wherein the two pipes are parallel.

FIG. 7 depicts the spigot end of a second pipe fitted into the bell socket end of a first pipe, the pipes secured by a sealing member fitted within the bell socket, wherein the second pipe is pivoted at an angle relative to the first pipe.

FIG. 8 depicts the spigot end of a second pipe fitted into the bell socket end of a first pipe, the pipes secured by a sealing member fitted within the bell socket, wherein the second pipe is pivoted at a different angle relative to the first pipe.

### DETAILED DESCRIPTION

The present disclosure generally pertains to systems and methods for an improved pipe joint. The system includes a first pipe having a bell socket end and a second pipe having a male or spigot end. The bell socket end of the first pipe is configured to include an inner groove within which a sealing member may be inserted. The bell socket end of the first pipe further includes a pivot cavity. The spigot end of the second pipe may be inserted into bell socket end of the first pipe to form a pivotable, unrestrained, push-fit, ring-seal assembly when operatively joined. The circumferential sealing area formed by the sealing member's interaction with the spigot of the second pipe defines a sealing plane that is longitudinally located in relatively close proximity with a pivot plane of the two pipes, thereby allowing a high deflection angle with a relatively low bell and sealing member mass.

The use of any and all examples, or exemplary language (“e.g.,” “such as,” or the like) provided herein, is intended merely to better illuminate the embodiments and does not pose a limitation on the scope of the embodiments.

As used herein, “alloy” means pure metals and metals including incidental impurities and/or purposeful additions of metals and/or non-metals. For example, alloy may mean aluminum. Other examples of alloys include brass, bronze, copper, duralumin, Inconel, nickel, steel, stainless steel, titanium, other alloys known to those skilled in the art, and combinations of the same.

As used herein, “composite” means engineered materials made from two more constituent materials. Examples of composites include, but are not limited to, carbon composites, in which carbon fiber is embedded in a matrix or resin, including epoxy matrices, thermosetting or thermoplastic resins, as well as composites containing fiberglass and other like materials known in the art.

As used herein, “pivot point” refers to a point where the centerline axis of a pipe intersects the centerline axis of another pipe as viewed in a two dimensional cross section view of a deflected pipe joint assembly. In three dimensions, the pivot point is a line unless the pipes are arranged perfectly concentric.

As used herein, “plastic” means a thermoplastic, a thermoset plastic, polyvinyl chloride or other extruded high molecular mass, organic polymer, and other plastics known in the art.

As used herein, “rubber” means any natural, cured, reclaimed, vulcanized and synthetic elastomers including, but not limited to, acrylic rubber, acrylonitrile butadiene rubber (nitrile or NBR), butyl rubber (IIR), ethylene propylene diene monomer (EPDM), fluoroelastomer rubber, hydrogenated nitrile rubber, styrene-butadiene rubber (SBR), silicone, and like flexible materials known in the art having elastic memory.

As used herein, “throat” refers to the smallest annular opening within a bell socket of a pipe that will allow the spigot of another pipe to enter the bell socket. In a conventional pipe joint the throat is formed by the inner surface of the bell socket which generally defines or is radially aligned with the axial location of the pivot point. In the present invention, the throat is formed by or essentially aligned with an elastomeric sealing member.

Throughout the accompanying drawings, identical or similar parts are represented by the same reference numerals and characters.

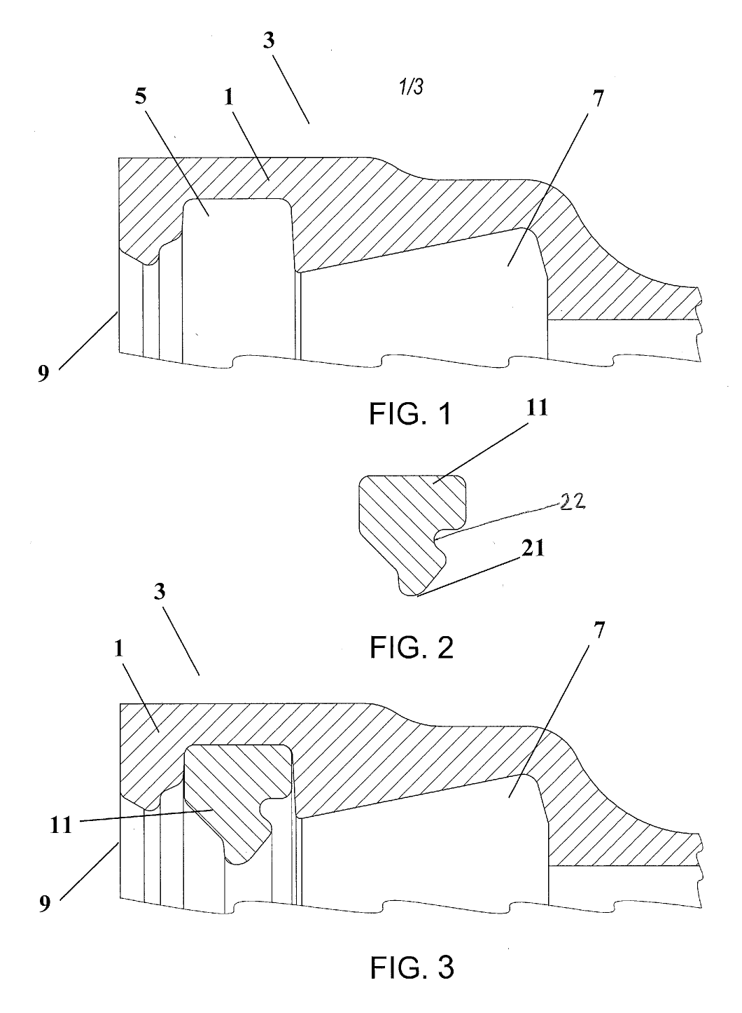

FIG. 1 depicts a female bell socket end 1 of a pipe 3. The bell socket 1 includes a groove spanning the inner circumference of the bell socket end 1 which forms a sealing surface 5 configured to accept a sealing member 11 such that the sealing surface 5 is complementary to the shape of the outer surface of the sealing member 11. As used herein, “sealing surface” 5 means a cavity or groove on the interior surface of the bell socket 1 configured to accept a sealing member 11 and to resist lateral movement of such sealing member 11. For example, the sealing surface 5 groove depicted in FIG. 1 is designed to accept the sealing member 11 depicted in FIG. 2 such that the outer surface of the sealing member 11 is in contact with the surface of the sealing surface 5. The sealing member 11 enhances the seal between the first pipe 3 and the second pipe 15 such that the seal is maintained regardless of the deflection angle at which the two pipes are positioned.

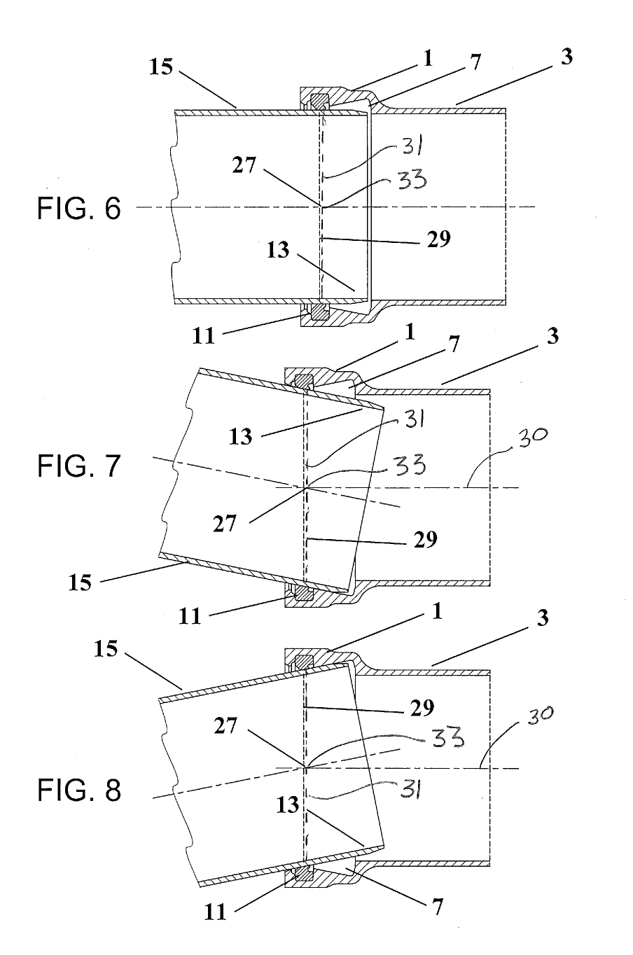

The bell socket 1 further includes a second groove which spans the inner circumference of the bell socket end 1 and forms pivot cavity 7, which is configured to allow the spigot end 13 of an inserted pipe 15 to pivot. The ability of the pipe 15 to pivot within the pivot cavity 7, for example, is depicted in FIGS. 6, 7, and 8. In certain embodiments, the inner surface of the pivot cavity 7 distal from the sealing surface 5 is concave relative to the interior of the first pipe 3 to allow the spigot end 13 of the second pipe 15 to pivot within the pivot cavity 7, such as is depicted in FIGS. 6, 7, and 8. In certain embodiments, the spigot end 13 of the pipe 15 is tapered such that the outer diameter of the pipe 15 decreases toward the spigot end 13. The pivot cavity 7 is located on the side of the sealing surface 5 that is distal from the bell socket end 1 aperture, and the depth of the pivot cavity 7 increases linearly with its distance from the sealing surface 5 such that the pivot cavity 7 is generally conical in shape. In other words, the depth of the pivot cavity 7 is greatest at the point of the pivot cavity 7 furthest from the sealing surface 5. The depth of the pivot cavity 7 may be adjusted in different embodiments to allow for different pivot, or deflection angles, between the first pipe 3 and the second pipe 15. For example, increasing the depth of the pivot cavity 7 will enable a greater deflection angle between the first pipe 3 and the second pipe 15. The conical shape of the pivot cavity 7 permits deflection of the first pipe 3 in any direction relative to the longitudinal axis of the second pipe 15.

In certain embodiments, the first pipe 3 and/or the second pipe 15 are generally cylindrical. In certain embodiments, the bell socket end 1 of the first pipe 3 is generally cylindrical. In other embodiments, the spigot end 13 of the second pipe 15 is generally cylindrical. In certain embodiments, the outer diameter of the spigot end 13 of the second pipe 15 is greater than the inner diameter of the first pipe 3, but less than the inner diameter of the bell socket end 1 of the first pipe 3. For example, the spigot end 13 of the second pipe 15 may be inserted into, but not beyond, the bell socket end 1 of the first pipe 3 as a result of the differential circumferences of the two pipes. This insertion limitation may serve as an indicator of proper insertion of the second pipe 15 into the first pipe 3. In certain embodiments, the first pipe 3 and/or the second pipe 15 are composed of an alloy. In other embodiments, the first pipe 3 and/or the second pipe 15 are composed of a composite. In certain embodiments, the first pipe 3 and/or the second pipe 15 are composed of plastic.

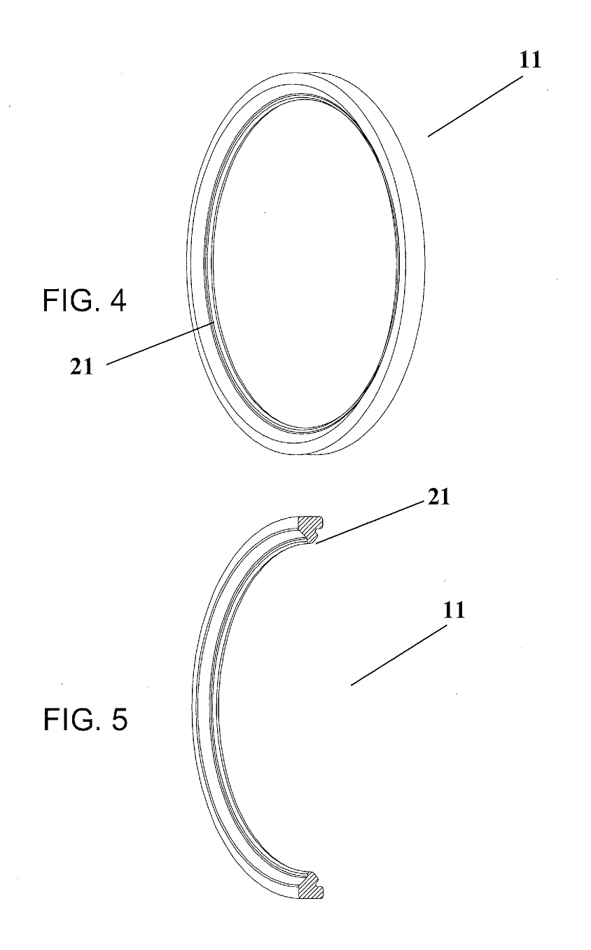

FIGS. 4 and 5 depict an exemplary embodiment of a ring-shaped sealing member 11. In certain embodiments, the sealing member 11 is compressible. In certain embodiments, the sealing member 11 is elastomeric. In certain embodiments, the sealing member 11 is composed of rubber. The sealing member 11 includes a foot portion including a contact surface 21, such as is depicted in the cross-section shown in FIG. 2. In certain embodiments, the foot portion including the contact surface 21 is more compressible than the remainder of the sealing member 11. In certain embodiments, the foot portion with the contact surface 21 extends radially inward toward the longitudinal center of the sealing member 11. As used herein, “contact surface” 21 means the inner surface of the sealing member 11 which makes contact with the outer surface of the spigot end 13 of the male pipe 15.

An annular channel 22 is provided on a radial edge of the sealing member. The annular channel 22 provides a space into which sealing member 11 can occupy when the second pipe 15 compresses sealing member 11 upon initial entry into the bell socket 1. The annular channel 22 thereby decreases the amount of force required to push the second pipe 15 into the bell socket 1 and through sealing member 11.

Referring to the pipe joint of FIGS. 6, 7 and 8, the contact surface 21 of sealing member 11 and the pivot point 27 of the two pipes are positioned within an annular band defined by the engagement of the compressible membrane 11 with the outer surface of the second pipe 15, such as is depicted in FIGS. 6, 7, and 8. The width of the longitudinal band is limited to the extent required to enable the second pipe 15 to pivot about the pivot point 27 such that the spigot end 13 of the second pipe 15 may pivot within the pivot cavity 7 within the socket end 1 of the first pipe 3. The width of the annular band along its length may be vary and is subject to change upon pivoting of the second pipe 15 within the bell socket 1 since pivoting of the second pipe 15 causes the compressible member to compress, thereby increasing the width of the band in the areas of compression, and decompress, thereby decreasing the width of the band in the areas of decompression. In certain embodiments, the first pipe 3 and second pipe 15 may pivot relative to one another in any direction, the angle of deflection limited by the width of the longitudinal band and the depth and angle of the pivot cavity 7. In certain embodiments, the maximum deflection angle of the pipe joint formed by the first pipe 3 and second pipe 15 is about 11.25 degrees. In certain embodiments, longitudinal width of the pipe joint formed by the two pipes is about 4 to 12 inches.

In certain embodiments, the pivot point 27 may be radially aligned with the sealing surface 5 and/or the sealing member 11. In certain embodiments, inner diameter of the throat is greater than an inner diameter of the sealing member 11. In certain embodiments, the contact surface 21 impinges against the second pipe 15 at a sealing point.

The present disclosure further contemplates a method of forming a pipe joint including the steps of: providing a first pipe 3 having a bell socket end 1, the bell socket end 1 including an annular groove forming a sealing surface 5 and a sealing member 11 located within the sealing surface 5, the sealing member 11 including a contact surface 21 extending radially inward, and a pivot groove configured to allow the pivoting of the spigot end 13 of a second pipe 15; positioning the first pipe 3 coaxially adjacent to the second pipe 15; inserting a spigot end 13 of a second pipe 15 through the opening 9 of the socket end 1, and the opening of the sealing member 11, of the first pipe 3; compressing the sealing member 11 between the sealing surface 5 and the spigot end 13 to produce a compressed sealing member 11 having an inner diameter; impinging the contact surface 21 against the outer surface of the second pipe 15; and pivoting the spigot end 13 within the bell end 1 about a pivot point 27 that is radially aligned with the sealing surface 5. FIGS. 6, 7 and 8, for example, illustrate the pivoting range of an exemplary pipe joint.

The resulting pipe joint includes pivot point 27 about which the second pipe 15 pivots relative to the first pipe 3. The pivot point 27 is coincident with a pivot plane 29 extending perpendicularly through a longitudinal axis 30 of the first pipe 3 and through the annular compressible member 11. A sealing plane 31 is also formed that extends perpendicularly through the longitudinal axis 30 of the first pipe 3 at a second point 33 and through a center of the width of the annular seal formed by the engagement of the sealing member 11 with the outer surface of the second pipe 15, the second point 33 being a desired distance from the pivot point 27 of 0% to 15% of the outer diameter of the spigot end.

In certain embodiments, the pipe joint described herein may be used for liquid supply pipes. For example, the pipe joint described herein may be used for piping applications including, but not limited to, water, liquid petroleum, and oil supply pipes and other like applications. In other embodiments, the pipe joint described herein may be used for gas supply pipes. For example, the pipe joint described herein may be used for piping applications including, but not limited to, natural gas supply pipes and other like applications.

A significant benefit of the pipe joint described herein is that such pipe joint allows the bell socket 1 to have significantly lowered mass compared with sockets used in conventional unrestrained pipe joints capable of similar deflection angles. Further, the bell socket 1 contemplated herein does not require a conventional metal throat, thereby reducing weight and increasing casting tolerances for the bell socket 1. Further, the spigot end 13 of the second pipe 15 may telescopically fit into the socket end 1 of the first pipe 3. These characteristics result in a lower cost bell socket 1 that is also easier to manufacture and install compared to conventional pipe joints.

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

The compositions of the various embodiments described herein are exemplary and are not intended to limit the interpretation of this disclosure. Various other embodiments for the pipe joints described herein are possible.

Now, therefore, the following is claimed:

1. A pipe joint comprising:
a first pipe having a bell end and a longitudinal axis, the bell end including an annular groove,
an annular compressible member located within the annular groove, the annular compressible member having an inner face defining an opening,
a second pipe having a spigot end with an outer diameter, the second pipe being inserted into the bell end and through the opening and pivotable relative to the first pipe,
an annular seal formed by and between the annular compressible member and the spigot end, and
a pivot point about which the second pipe pivots relative to the first pipe, the pivot point being coincident with a pivot plane extending perpendicularly through the longitudinal axis of the first pipe and through the annular compressible member.

2. The pipe joint of claim 1 further comprising a sealing plane that extends perpendicularly through the longitudinal axis of the first pipe at a second point and through the annular seal, the second point being a desired distance from the pivot point, the desired distance being equal to 0% to 15% of the outer diameter of the spigot end.

3. The pipe joint of claim 1 further comprising a sealing plane that extends perpendicularly through the longitudinal axis of the first pipe at a second point and through the annular seal, the second point being a desired distance from the pivot point, the desired distance being equal to 0% to 10% of the outer diameter of the spigot end.

4. The pipe joint of claim 1 further comprising a sealing plane that extends perpendicularly through the longitudinal axis of the first pipe at a second point and through the annular seal, the second point being a desired distance from the pivot point, the desired distance being equal to 0% to 5% of the outer diameter of the spigot end.

5. The pipe joint of claim 1 further comprising a sealing plane that extends perpendicularly through the longitudinal axis of the first pipe at a second point and through the annular seal, the second point being a desired distance from the pivot point, the desired distance being equal to 0% to 3% of the outer diameter of the spigot end.

6. The pipe joint of claim 2 wherein the sealing plane extends through a center of a width of the annular seal.

7. The pipe joint according to claim 1 wherein the annular compressible member includes an annular channel extending along a proximal face thereof, the annular channel being configured for promoting a sealing portion of the gasket to compress axially when the spigot end is inserted through the opening.

8. The pipe joint according to claim 1 wherein the annular compressible member excludes a rigid locking segment.

9. The pipe joint according to claim 2 wherein the annular compressible member exhibits a hardness along the pivot plane that is greater than along the sealing plane.

10. A method of making a pipe joint comprising:
inserting a spigot end of a first pipe through an opening of an annular gasket that is seated within an annular groove of a bell end of a second pipe, and
pivoting the first pipe relative to the second pipe about a pivot point that is coincident with a pivot plane that extends perpendicularly through a longitudinal axis of the second pipe and through the annular gasket.

11. The method according to claim 10 further comprising forming an annular seal between the annular gasket and the spigot end, the annular seal having width.

12. The method according to claim 11 wherein a sealing plane extends through a center of the width of the annular seal and perpendicularly through the longitudinal axis of the second pipe at a second point, the second point being a desired distance from the pivot point that is from 0% to about 15% of an outer diameter of the spigot end.

13. A pipe joint comprising:
a pivot point about which a first pipe is pivotally coupled to a second pipe, the pivot point being coincident with a longitudinal axis of the second pipe,
a pivot plane that extends through the pivot point and perpendicularly to the longitudinal axis of the second pipe, and
a sealing member arranged between the first pipe and the second pipe,
wherein the pivot plane extends through the sealing member.

14. The pipe joint according to claim 11 wherein the sealing member includes a channel on a radially extending face therefore.

15. The pipe joint according to claim 11 including a sealing plane that extends perpendicularly through the longitudinal axis of the second pipe at a second point and through the sealing member.

16. The pipe joint according to claim 13 wherein a distance between the pivot point and the second point is equal to about 0% to about 15% of an outer diameter of the first pipe along the pivot plane.

17. The pipe joint according to claim 13 wherein a distance between the pivot point and the second point is equal to about 0% to about 5% of an outer diameter of the first pipe along the pivot plane.

18. The pipe joint according to claim 13 wherein a distance between the pivot point and the second point is equal to about 0.1% to about 2% of an outer diameter of the first pipe along the pivot plane.

19. The pipe joint according to claim 13 wherein the sealing plane extends through a center of a width of an annular seal formed between the first pipe and the sealing member.

20. The pipe joint according to claim 11 wherein the second pipe includes a bell end into which the first pipe is inserted.

21. The pipe joint according to claim 13 wherein a hardness of the sealing member is greater along the pivot plane than along the sealing plane.

22. The pipe joint according to claim 11 wherein the first pipe and the second pipe are constructed from ductile iron.
